(19) United States
(12) Patent Application Publication
(10) Pub. No.: US 2025/0085405 A1
(43) Pub. Date: Mar. 13, 2025

(54) WIDE-FIELD-OF-VIEW STATIC LIDAR

(71) Applicants: CENTRE NATIONAL DE LA RECHERCHE SCIENTIFIQUE, Paris (FR); UNIVERSITE PARIS-SACLAY, GIF-SUR-YVETTE (FR)

(72) Inventor: Jean-Paul CROMIERES, ORSAY (FR)

(73) Assignees: CENTRE NATIONAL DE LA RECHERCHE SCIENTIFIQUE, Paris (FR); UNIVERSITE PARIS-SACLAY, GIF-SUR-YVETTE (FR)

(21) Appl. No.: 18/722,116

(22) PCT Filed: Dec. 16, 2022
(86) PCT No.: PCT/EP2022/086416

§ 371 Date: Jun. 20, 2024

(30) Foreign Application Priority Data
Dec. 21, 2021 (FR) FR2114182

(51) Int. Cl. G01S 7/4865; G01S 7/481; G01S 17/10

(52) U.S. Cl. CPC G01S 7/4865; G01S 7/4816; G01S 17/10

(57) ABSTRACT

A method for processing a signal from a lidar including digitizing the amplified electrical signal (s₀^{e}(t)), applying at least one time correction function, referred to as the correcting filter (C^{e}(t)), to the digitizing amplified electrical signal in order to generate a processed signal (sf(t)), the correcting filter (C^{e}(t)) being determined based on the impulse response and a predetermined time analysis function, the analysis function having at least one non-zero value, referred to as the discontinuity, at a given time referred to as the discontinuity time, with a return to substantially zero values around the discontinuity; and determining a distance (di) of the at least one element (Ei) based on the processed signal.

### FIELD

The present invention relates to the field of time-of-flight (TOF) lidars, and more particularly to lidars with a field-of-view greater than 5°. The focus here is on static lidars (with no moving mechanical parts) for low power consumption, small size and low cost. This type of lidar has applications in obstacle detection, for example.

### BACKGROUND

A lidar (Light Detection And Ranging) is a device used to measure distance by measuring the time of flight of a light pulse.

It emits a high-power, short-duration light pulse (typically a few ns), and recovers a reflected/backscattered pulse from an obstacle some time later. Knowing the propagation speed of light, the distance is deduced from this delay, called the time of flight. It is calculated according to the formula

$$d = \frac{c . R}{2} \qquad ( 1 )$$

where c=3.10⁸ m/s is the speed of light, and R is the delay due to the distance d between the transmitter and the obstacle. Thus, for an obstacle 1m away, the delay is assumed to be 6.67 ns.

The lidar consists of:
an optical pulse emitter (laser diode or light-emitting diode), controlled by a logic component such as a microprocessor, microcontroller or FPGA
an optoelectronic receiver whose role is to convert the reflected pulse into an electrical signal while maintaining measurement quality, in particular by maximizing the measurement signal-to-noise ratio (S/N)
a device for processing the electrical signal supplied by the receiver to deduce the distance to the obstacle. This device may be a time-to-distance converter (TDC), or a digital signal processing system based on a microprocessor, microcontroller or FPGA.

Typically, when using a laser diode emitter, the optical power emitted can be as high as a few tens of watts over a period of a few nanoseconds. The orders of magnitude of power received from echoes typically range from a few nanowatts to a few hundred milliwatts. Light output can vary from zero for complete darkness to 1 kW/m² (120 klux) in full sunlight. An illuminance of 10 W/m² corresponding to average artificial lighting illuminating a 5×5 mm² silicon photodiode will generate a photogeneration current of around 500 pA, while full sunlight will generate a current of around 20 mA.

Lidars are used to measure distances, map surfaces and detect objects. There are several types of lidars:

The 1D lidar, often narrow-field, features a pulsed light beam emitted with a small aperture (narrow-field-of-view (FOV) lidar). It measures the distance from a precise point, where the object is located. Optoelectronic components (beam-emitting diode, receiving photodiode) are then often combined with optical components (lenses, filters, etc.) to collimate and focus the beams. These narrow-field (typically less than 3°), short-range 1D lidars are marketed for obstacle detection applications in lightweight applications for autonomously or semi-autonomously moving objects such as drones or robots in the broadest sense (autonomous vacuum cleaners and lawnmowers, radio-controlled vehicles with obstacle detection, etc.). They have supplanted the traditional ultrasonic rangefinders, whose field of view is much wider and whose first detected obstacle is not exactly known.

1D lidars have the advantage of being relatively compact and inexpensive, but have a major drawback in that their field of view is narrow, at less than 3° (Safran LRF3013, Benewake TF02).

Since obstacle detection requires a wide field-of-view, this role is currently fulfilled by 3D lidars using scanning technology. The pulse beam also has a small aperture, but is coupled with a mechanical scanning system to irradiate an entire portion of space: A plurality of beams directed at different locations are required to produce a map. 3D lidars enable precise mapping of the environment using mechanical systems of varying complexity, or MEMS (Micro Electro Mechanic Systems). They are effective, but have the disadvantage of being oversized for light applications, in terms of:
Volume of data: Precise mapping requires extensive processing of data, not all of which can be expected to be processed
Large physical form factor
High power consumption (more than 1 W in most cases)
Low measurement refresh rate (a few tens of Hz)

This is why, in the field of reversing radars that need to detect obstacles in a wide field-of-view, camera-based devices rather than lidars have supplanted or supplemented ultrasonic sensors. For collision avoidance, the wide field of an ultrasonic sensor is an advantage over traditional 3D lidar, which needs to be mounted on a turntable to scan a wide field. Ultrasonic sensors are also easier to use because of the low propagation speed of acoustic waves compared with electromagnetic waves, which means that echo times are much longer and easier to measure. These are used in a wide range of applications, such as vehicle collision avoidance, robotics, and detection of the presence of objects or living beings.

However, the characteristics of the wavelength and propagation speeds of acoustic waves mean that ultrasonic sensors have fundamental shortcomings:
high sensitivity to atmospheric and environmental conditions: humidity, rain, temperature, noise, and it is difficult to obtain ranges beyond one meter with reasonable sensitivity in these climate conditions
the presence of parasitic secondary lobes in the measurement field, with the risk of false detections
insensitivity to low-roughness surfaces (less than a mm) viewed at high incidence (total reflection prevents detection)
difficulty in detecting fine objects, small dimensions or surfaces
slow measurement is a limitation to the detection of obstacles moving relative to the sensor

A lidar with the wide-field properties of ultrasonic sensors, illuminating a scene at a cone angle of more than 5°, or even 100 or 20°, would be able to scan a large portion of space and detect echoes from different elements/obstacles present in the scene or field of observation, with the possibility of a single pulse (no need for scanning). What's more, a wide-FOV lidar, which is virtually impervious to high humidity and/or rain and capable of detecting a smooth painted surface at high incidence, would have a competitive advantage in anti-collision applications still reserved for ultrasound. It could also be used for autonomous movement of robots or drones.

But the wide field is not lidar's natural domain. This is because the backscattered optical flux decreases with distance (d) to d⁻⁴ for small objects, instead of decreasing to d⁻² for a narrow field, which limits its range. The difference is in the density of incident light intensity. In a so-called “narrow” field, it is assumed that all incident energy is included on the surface of the obstacle (in other words, the surface area of the obstacle is greater than the surface area illuminated at the solid angle): The obstacle receives all the energy from the transmitter. Each point on the obstacle then backscatters energy towards the receiver according to a d⁻² law. In the case of a wide field, the obstacle is totally included in the illumination cone: the obstacle receives only part of the transmitter's energy according to a d⁻² law, and backscatters this energy towards the receiver also according to a d⁻² law, with total energy on the receiver being d⁻⁴ of the transmitter's energy.

In addition, large objects in the background mask small ones in the foreground, for reasons explained later. Centimetric resolution is more difficult to achieve, and costs are higher than for ultrasonic sensors.

Typically, the receiver has a known impulse response hr(t), determined by measurement or calculation. One prior art method of processing a lidar signal is to operate in Fourier space. The signal at the receiver output is digitized and its Fourier transform calculated, then a filter F0(f) is applied whose transfer function is close to the inverse of the Fourier transform of hr(t):

F0(f)=1/Hr(f) where Hr(f) is a Fourier transform of hr(t).

These methods, commonly referred to as spectrum whitening through a whitening filter, are widely described in the literature, but raise a number of stability and complexity issues. In most cases, they require a high level of computing power, which puts them out of reach to a simple, low-power on-board microprocessor. They also pose processing problems, as the presence of noise introduces divisions by zero into the calculations.

One aim of the present invention is to overcome some of the aforementioned drawbacks by proposing a lidar signal processing method for a wide-field-of-view TOF lidar, making it possible to discriminate the elements/obstacles present in the illuminated scene and to determine their distance, all in a single laser shot.

### SUMMARY

The object of the present invention is a method for processing a signal from a lidar, said lidar performing a time-of-flight measurement and comprising an emitting device configured to emit light pulses in the direction of a scene at an angle greater than or equal to 5° and a receiving device, said receiving device exhibiting an impulse response and comprising a photodetector configured to receive pulses reflected or backscattered by at least one element of the scene and to convert said pulses into an electrical signal, and an amplification circuit configured to generate an amplified electrical signal, the method comprising the steps of:
A: digitizing said amplified electrical signal
B: applying at least one time correction function, referred to as the correcting filter, to said digitizing amplified electrical signal in order to generate a processed signal, said correcting filter being determined based on the impulse response and a predetermined time analysis function, the analysis function having at least one non-zero value, referred to as the discontinuity, at a given time referred to as the discontinuity time, with a return to substantially zer□values ar□und the disc□htinuity;
C: determining a distance (di) of said at least one element (Ei) based on the processed signal.

According to one embodiment, applying the correcting filter consists in convolving the digitized amplified electrical signal with said correction time function, said correcting filter being determined by deconvolution of said impulse response by said predetermined analysis function.

According to one embodiment, a presence of said at least one element in said scene corresponds to a local maximum of said processed signal, and said associated distance is determined from a temporal location of said local maximum.

According to one embodiment, said impulse response has a maximum at a time tₘ₋ᵢₘₚ, and said at least one discontinuity time of the analysis function is located temporally in the vicinity of said time tₘ₋ᵢₘₚ.

In one embodiment, the analysis function has zero values outside said at least one discontinuity.

According to one embodiment, an analysis function has either a single discontinuity, two discontinuities or three discontinuities, located respectively at discontinuity times close together in time.

According to one embodiment, a plurality of correcting filters determined from a plurality of analysis functions are applied so as to generate a plurality of associated processed signals, said distance of said at least one element in the scene being determined from said plurality of processed signals.

In one embodiment, said plurality of correcting filters is applied via an iterative process, until a final processed signal allows the determination of a distance corresponding to the nearest obstacle.

In one embodiment, the iterative process consists in modifying discontinuities, i.e. non-zero values of said analysis functions.

In one embodiment, a correcting filter corresponding to an analysis function with a single discontinuity is first applied, followed by analysis functions with two discontinuities or three discontinuities, said discontinuities being iteratively modified.

According to another aspect, the invention concerns a time-of-flight lidar system comprising:
an emitting device configured to emit light pulses towards a scene at an angle greater than or equal to 5°
a receiving device having an impulse response and comprising:
a photodetector configured to receive pulses reflected or backscattered by at least one element in the scene, and to convert said pulses into an electrical signal,
an amplification circuit configured to amplify said electrical signal,
a processing unit of said amplified electrical signal configured to:
digitize said amplified electrical signal,
apply at least one time correction function, referred to as the correcting filter, to said digitizing amplified electrical signal in order to generate a processed signal (sf(t)), said correcting filter being determined based on the impulse response and a predetermined time analysis function, the analysis function having at least one non-zero value, referred to as the discontinuity, at a given time referred to as the discontinuity time, with a return to substantially zer□values ar□und the disc□htinuity;
determine a distance of said at least one element based on the processed signal.

According to one embodiment, the amplification circuit comprises a transimpedance amplifier, a transformer comprising a primary and a secondary, and a capacitor, the primary of the transformer being connected to an anode of the photodetector, the secondary being connected to a capacitor, said capacitor being connected to an input of said transimpedance amplifier.

The following description presents several examples of the device of the invention: these examples do not limit the scope of the invention. These example embodiments present both the essential features of the invention as well as additional features related to the embodiments considered.

### BRIEF DESCRIPTION OF THE FIGURES

The invention will be better understood and other features, purposes, and advantages thereof will become apparent in the course of the detailed description which follows and with reference to the appended drawings given by way of non-limiting examples and wherein:

FIG. 1A shows a lidar according to the invention.

FIG. 1B shows a drone in the process of landing, equipped with a 1D lidar according to the prior art.

FIG. 1C shows a drone in the process of landing, equipped with a lidar according to the invention.

FIG. 2 shows the change in convolution for four time values, for the situation shown in FIG. 1.

FIG. 3 shows the s₀(t) signal obtained at the receiver output.

FIG. 4 shows the concept of a fictitious obstacle.

FIG. 5 shows the change over time of various signals of interest.

FIG. 6 shows the lidar signal processing method according to the invention.

FIG. 7 shows the measurement and processing chain.

FIG. 8 shows the corrected impulse response.

FIG. 9 shows the timing method, which transforms the receiver's unprocessed impulse response into a predetermined analysis function.

FIG. 10 shows the coefficients of the correction function, calculated by deconvolution of the impulse response by the predetermined analysis function.

FIG. 11 shows the effect of an analysis function with a single discontinuity on an Ir signal.

FIG. 12 shows the limitation of an analysis function with a single discontinuity of a certain width on an Ir signal.

FIG. 13 shows an analysis function with a single discontinuity.

FIG. 14 shows an analysis function with two discontinuities.

FIG. 15 shows a variant of the method according to the invention, wherein the correcting filter is applied iteratively.

FIG. 16 shows the raw and processed signals for a first configuration of three obstacles.

FIG. 17 shows an example of a single Dirac analysis function (A) and an example of a dual-Dirac analysis function (B).

FIG. 18 shows the processed signal for a second configuration of three obstacles.

FIG. 19 shows the processed signal for a third configuration of three obstacles.

FIG. 20 shows the signals processed for the third configuration iteratively processed by a dual-Dirac analysis function.

FIG. 21 shows a lidar receiving device according to the prior art.

FIG. 22 shows a receiving device according to a variant of the lidar according to the invention.

### DETAILED DESCRIPTION

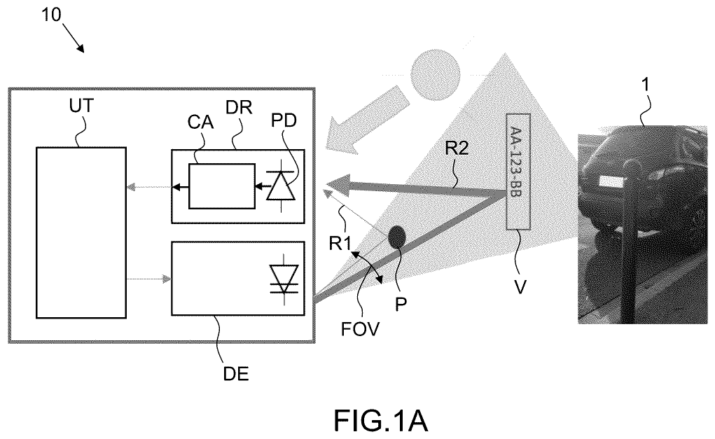

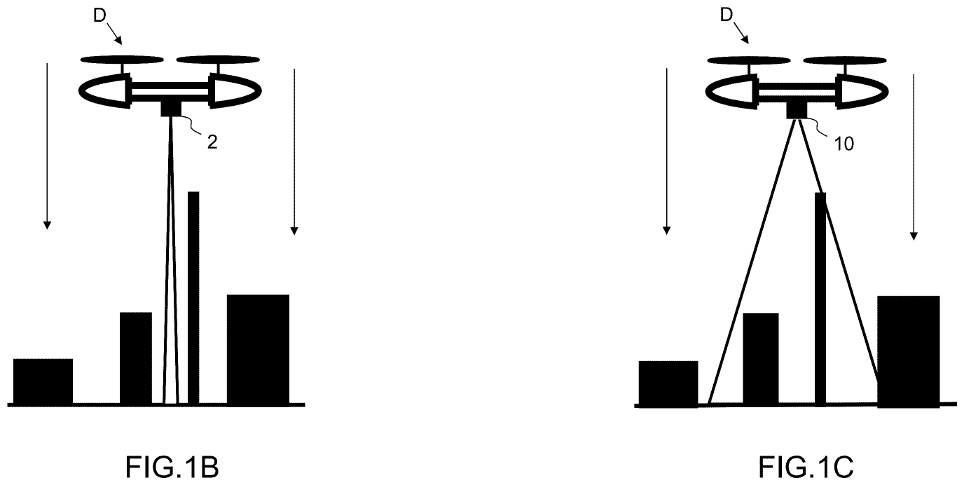

A wide-FOV TOF lidar 10 according to the invention is shown in FIG. 1A. It comprises an emitting device DE configured to emit light pulses towards a scene at an angle (FOV) greater than or equal to 5°, preferentially 10°. The emitting element is, for example, a laser diode or a light-emitting diode. The choice of wavelength for a lidar according to the invention is broader than for a narrow-field lidar, because for eye safety, using a wide field greatly limits the risks. Preferably, the illumination wavelength is chosen close to the detector's maximum sensitivity, in order to optimize reception.

Lidar 10 also includes a receiving device DR (or receiver) comprising a photodetector PD configured to receive pulses reflected or backscattered by at least one element (Ei, i=element index) of the scene and to convert the reflected pulses into an electrical signal, and an amplifier circuit CA configured to amplify the electrical signal. Conventionally, the receiver (photodetector and amplifier circuit) has an impulse response hr(t) that can be measured and/or calculated.

A processing unit UT controls the emission, typically via a logic component of the microprocessor, microcontroller or FPGA type, digitizes the amplified electrical signal, and processes it to extract the useful information, that is the presence of elements in the detection field and their respective distance. The processing unit UT of the lidar according to the invention implements a particular processing method according to the invention described below.

In the example shown in FIG. 1A, there are two elements E1 and E2 in the detection field, a pole P and a vehicle V respectively. The initial pulse Ii is emitted at time t=0, and the photodetector receives, at time t1, a first pulse Ir1 from the backscatter of the pole P and, at time t2, a second pulse Ir2 from the backscatter of the vehicle V. The detector may also receive ambient light, such as sunlight. For the example of a reversing lidar according to the invention mounted on a vehicle V, photo 1 shows the scene illuminated by the lidar on vehicle V. In general, the lidar according to the invention can be mounted on any moving object: a car, a drone, a robot, a visually impaired person's walking stick, etc. For it to work properly, the lidar must detect the presence of the pole P and determine its distance d1 without being impeded by the backscatter from the vehicle V.

According to another example, the lidar is static and detects the presence of static or moving objects.

The use of a wide field-of-view proximity lidar according to the invention, as shown in FIG. 1, involves measurement peculiarities and difficulties. The wide detection field means that a plurality of obstacles may be contained within it. This differs from many other lidar applications, where transmitter aperture angles are reduced by the addition of specific collimation optics, resulting in the presence of a single obstacle in the analysis field.

FIG. 1B shows a drone D descending over rough terrain equipped with a 1D lidar 2 according to the prior art: the obstacle detection is uncertain due to the narrow field of view.

FIG. 1C shows the same drone equipped with a lidar 10 according to the invention, which, thanks to its wide field of view and signal processing according to the invention, enables accurate detection of obstacles.

A first consequence of opening the field is the spatial spreading of the emitted energy, leading to less illumination of obstacles, which in turn provide lesser echoes, these being more difficult to measure than in the case of a focused or collimated beam emission. This point, which is also conducive to eye safety, raises the question of the measurement signal-to-noise ratio.

A second consequence of opening up the detection field is the greater probability of finding a strong emissive source, such as the sun.

Finally, the proximity of obstacles means short echo times, which in turn requires fast detection electronics.

In the remainder of this document, we assume that the emitter supplies a perfectly located light pulse of the Dirac function type:

$${I}_{i} ( t ) = δ ( t ) .$$

An obstacle at distance d₁ will reflect part of the energy of this pulse, called an echo, back to the receiver. The echo can be described by the following relationship:

$${I}_{r 1} ( t ) = {a}_{1} δ ( t - R ) with {R}_{1} = \frac{{d}_{1}}{c} ,$$

where c is the speed of light, a₁ the amplitude, R₁ the delay caused by the distance d₁ between the transmitter and the obstacle.

If there are N obstacles in the detection field, the receiver measures an optical signal consisting of the sum of the echoes:

$${I}_{r} ( t ) = {\sum }_{n = 1}^{N} {a}_{n} δ ( t - {R}_{n} ) \qquad ( 2 )$$

In addition to these information-carrying optical signals, there is an illuminated background A₀ (ambient lighting, sun) considered here to be constant or slightly variable, resulting in the overall optical signal

$${I}_{g l} ( t ) = {A}_{0} + {\sum }_{n = 1}^{N} {a}_{n} δ ( t - {R}_{n} ) \qquad ( 3 )$$

Conventionally, the recovery of the optical signal I_{gl}(t) by the receiver, then its conversion into an amplified electrical signal s₀(t) by means of an amplifier system, is accompanied by certain modifications to the signal. Amplification is inevitably associated with the addition of measurement noise ñ(t) and limited bandwidth. This limitation results in a temporal broadening of each reflected pulse by convolving the pulses and the impulse response hᵣ(t) of the detector-amplifier (receiver) assembly:

$${s}_{0} ( t ) = [ {I}_{g l} ( t ) + \tilde{n} ( t ) ] * {h}_{r} ( t ) \qquad ( 4 )$$

The direct consequence of noise is an error in the temporal location of the return moment of an echo pulse, or even the impossibility of detection if that pulse is drowned out in noise.

The amplifier's limited bandwidth makes it difficult, if not impossible, to discriminate between echo pulses that are too close together. In fact, the impulse response hᵣ(t) of the receiver (detector and amplifier circuit) is directly linked to its frequency response, and therefore its bandwidth. According to the results of Fourier analysis theory for linear systems (here the receiver), a low bandwidth will lead to a long impulse response.

For the sake of understanding, we remind you that the convolution operator denoted * has the following generic mathematical expression:

$${s}_{0} ( t ) = ( {h}_{r} * {I}_{r} ) ( t ) = \int {h}_{r} ( u ) {I}_{r} ( t - u ) du . \qquad ( 5 )$$

In the following, we ignore noise and the continuous component of illumination. In equation (5), the input variable is a light intensity Iᵣ, the output variable is a voltage s₀(t), and hᵣ(t) is the impulse response of the photodetector+amplifier assembly.

Taking the example of a scene with two echoes:

$${I}_{r} ( t ) = {I}_{r 1} ( t ) + {I}_{r 2} ( t ) = I 1 ( t - R 1 ) + I 2 ( t - R 2 )$$

with I1 and I2 respectively proportional to a1 and a2 (formula (2)).

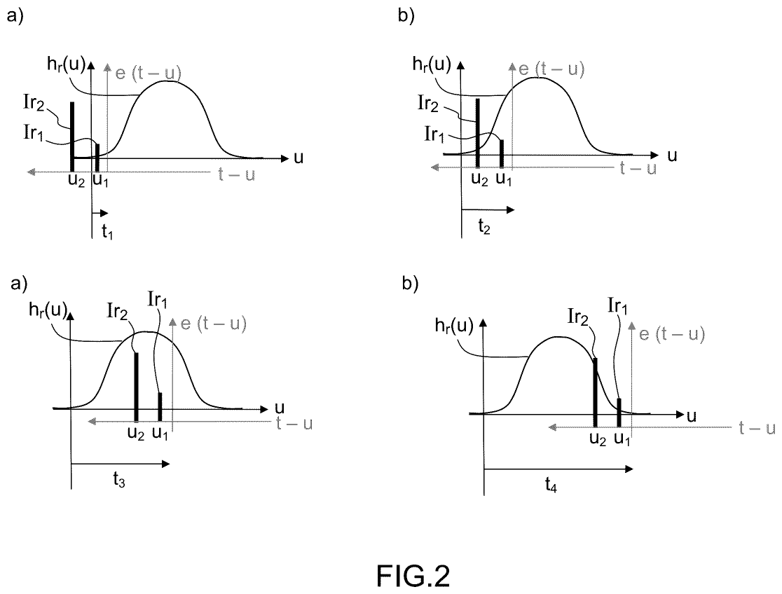

As an illustration, FIG. 2 shows the convolution evolution for four values of t, t′₁ to t′₄ for the situation shown in FIG. 1, with a thin pole P returning little echo (Ir1) placed in front of a car V returning more echo (Ir2):

a) t=t₁: Only the pulse lr1 interacts with the impulse response hᵣ. The common area between the pulse and the impulse response is small, so the output signal is also small and starts to grow slowly.
b) t=t₂: The two pulses Ir1 and Ir2 interact with the impulse response hᵣ. Common surfaces increase, and the output signal increases, due to the interaction of the two pulses with the impulse response.
c) t=t₃: The two pulses interact with hᵣ to maximum effect. Common surfaces are maximized, as is the output signal.
d) t=t₄: both pulses slowly exit the impulse response hᵣ, first the pulse Ir1 then the pulse Ir2. The common surfaces slowly decrease, the output signal slowly declines.

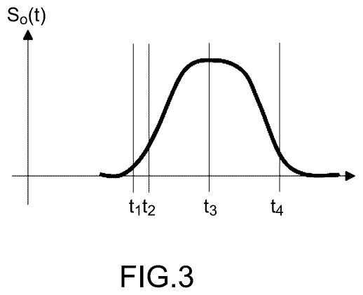

FIG. 3 shows the s₀(t) signal obtained at the receiver output.

Standard processing of the signal from the receiver to detect the presence of an obstacle is carried out by searching for the maximum and the associated time tm, which is assumed to correspond to the echo of an obstacle to be detected and therefore to the delay R. The distance to the obstacle is then determined using formula (1), where tm is the delay linked to the distance (time of flight).

FIGS. 2 and 3 show that the output signal from the receiver is the result of interaction with just one of the two pulses only at the beginning or end of the cycle, where the impulse response is most progressive, i.e. where the output signal increases or decreases most slowly. In the end, the observed output signal s₀(t) is almost always the result of the receiver's interaction with the two pulses, with no clear distinction between the effects of one or the other. For example, the effect of moving the two pulses apart and, above all, closer together would make little difference to the output signal. Time discrimination is therefore not possible.

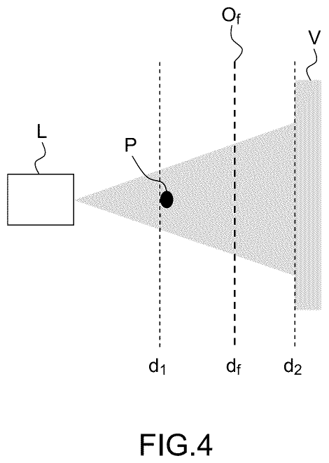

The maximum of s₀(t) is a sort of center-of-gravity of the two echo pulses as a function of their respective amplitudes and delays (ai, ti), corresponding in the end to a fictitious obstacle, instead of two real ones: Standard processing identifies a fictitious obstacle Of at t′3, corresponding to a distance df, and not two obstacles at distances d1 and d2, as shown in FIG. 4. Without taking into account the presence of a plurality of echoes, this fictitious obstacle is always located further away than the nearest obstacle. As an example: One obstacle is located at d₁=1 m, and another one further away at d₂=3 m. The dummy obstacle will be located between d₁≤dummy obstacle≤d₂. The lower the amplitude ratio a₂/a₂, the further away it is from d₁.

Thanks to the convolution effect, two close echo pulses interacting with a broad impulse response will be fully included in this impulse response at the same time, with no possibility of distinguishing between them. Thus, a conventional lidar L performing standard processing at the output of the amplification circuit is unable to discriminate between two nearby obstacles in the field of view.

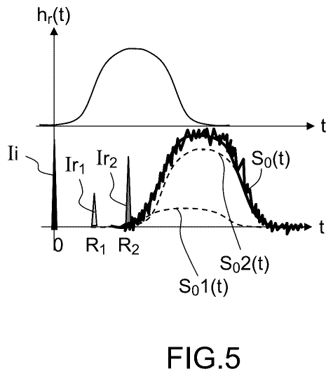

FIG. 5 summarizes the previous analysis and shows the temporal evolution of various signals of interest. The initial pulse Ii is transmitted t=0, the pulse Ir1 (pole) is received at R1 and the pulse Ir2 (vehicle) at R2. Signal s₀1(t) corresponds to the (noise-free) response of the amplification circuit to the presence of the pole alone, signal s₀2(t) to the (noise-free) response of the amplification circuit to the presence of the vehicle alone, and signal s₀(t) to the response of the amplification circuit to the presence of both obstacles, additionally taking into account measurement noise. From s₀(t) it is impossible to discriminate between the two obstacles.

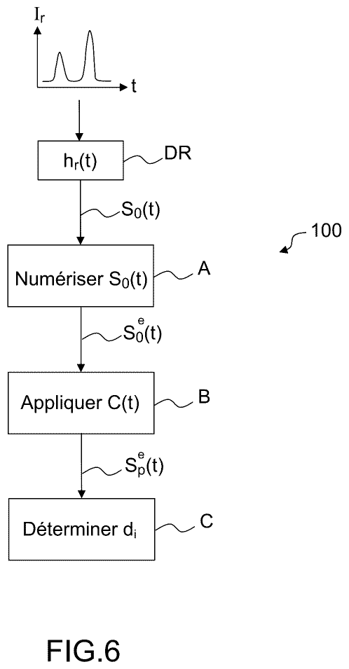

The processing unit of the lidar 10 according to the invention implements a method 100 for processing the received signal to solve the aforementioned problem of non-discrimination of obstacles, shown in FIG. 6.

Another aspect of the invention concerns a lidar signal processing method 100, which applies to a lidar mounted on a static or moving object, and enables obstacles to be detected in front of the lidar.

It comprises a first step A of digitizing the amplified electrical signal s₀(t). We have denoted this digitized signal as s₀^{e}(t)), and the sampling frequency as Fe. Compared to analog systems, a digital system is different in that it only knows the information at sampling instants Tₑ=1/Fₑ. The designation of digital information is indicated here by the exponent e for the signals resulting from the various processes.

In step B, at least one temporal correction function, called a correcting filter C^{e}(t), is applied to the digitized amplified electrical signal s₀^{e}(t), so as to generate a processed signal s₀^{e}(t). Preferably, the correcting filter is applied by convolving the digitized amplified electrical signal s₀^{e}(t) with the correction time function C(t), also digitized:

$${s}_{p}^{e} ( t ) = ( {s}_{0}^{e} * {C}^{e} ) ( t ) \qquad ( 6 )$$

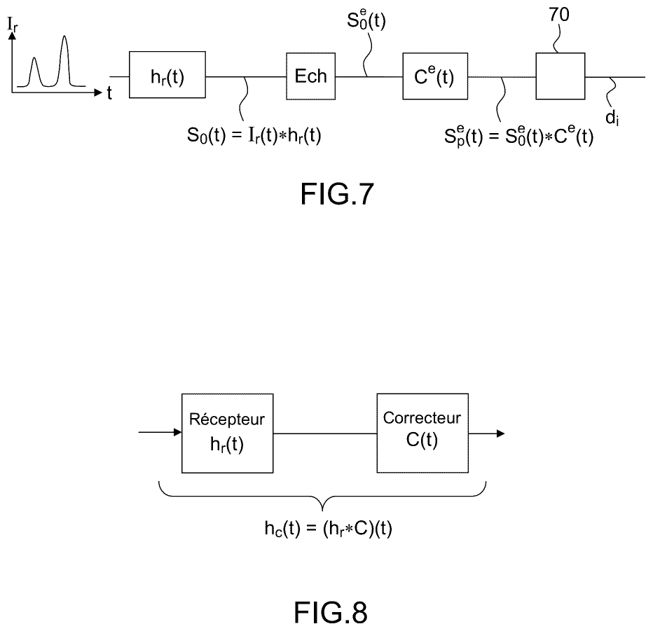

The signal s₀(t) at the output of the receiving device is conventionally determined by convolving the input light pulse Ir(t) with the impulse response hr(t) of DR (formula (5)). The measurement and processing chain is shown in FIG. 7.

The filter C^{e}(t) acts in the time domain, directly on s₀^{e}(t); there is no transformation to Fourier space. The filter C^{e}(t) filter applied is designed to improve the temporal resolution of the detection to discriminate obstacles. C^{e}(t) is determined from the sampled impulse response hᵣ^{e}(t) and a predetermined (desired) time analysis function h_{c}^{e}(t). It's as if the response hr(t) had been replaced by a corrected impulse response hc(t), thanks to the corrector C(t), as shown in FIG. 8 and formula (7) below. The purpose of introducing a discontinuity into the analysis function (see below) is to obtain a corrected impulse response with a break in slope that enables obstacles to be discerned.

$$hc ( t ) = ( hr * C ) ( t ) \qquad ( 7 )$$

To implement the method 100 according to the invention, it is therefore necessary to know the impulse response hr(t) (measurement and/or simulation), which is digitized and stored.

The transformation from the initial impulse response hr to the desired impulse response he is performed using a time-based method.

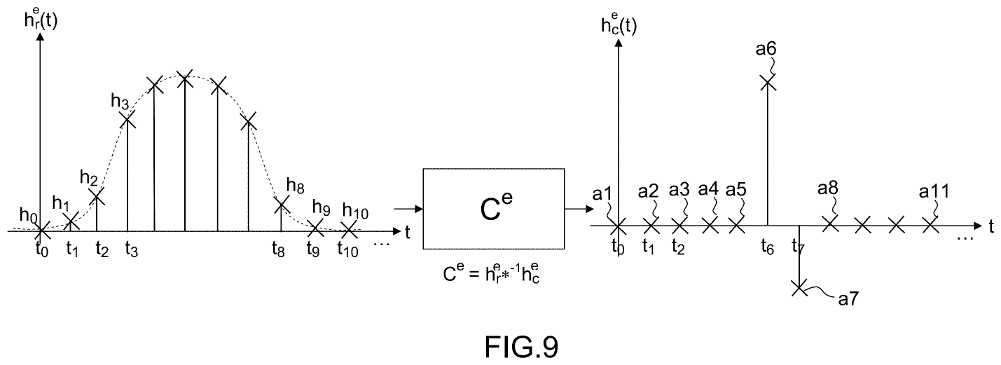

The various calculations are of course performed on the digitized values of these functions, as shown in FIG. 9. We have used the following terms:
h0, h1, h2 . . . the various digitized values of the impulse response hr(t) at sampling times t0, t1, t2 . . .
c0, c1, c2 . . . the various digitized values of the correction function C(t) at sampling times t0, t1, t2 . . . ,
a0, a1, a2, . . . the various digitized values of the analysis function hc(t) at sampling times t0, t1, t2 . . . . (in this example, the analysis function has two discontinuities with values a6 and a7 at two successive sampling times t6 and t7, the other values being zero).

The correcting filter C is determined by deconvolving the impulse response hr by the analysis function hc:

$$C ( t ) = ( h {r}^{* - 1} h c ) ( t ) \qquad ( 8 )$$

Applied to the digitized values, the coefficients ck of the corrector are determined using the following formulas:

$${c}_{0} = \frac{{a}_{0}}{{h}_{0}}$$

$${c}_{k \geq 1} = \frac{1}{{h}_{0}} ( {a}_{k} - {\sum }_{m = 1}^{n} {h}_{m} \cdot {c}_{k - m} )$$

Note that calculating the correction coefficients requires dividing by h0, which can cause numerical problems when h0 has a very low or even zero value. One solution is to add a constant to the entire impulse response and calculate the coefficients. The value of the constant is increased by successive iterations until convergent values of the coefficients are reached.

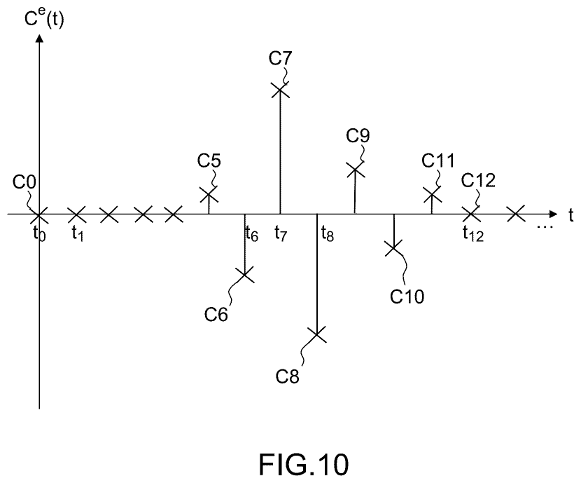

An example of these coefficients ck is shown in FIG. 10.

The predetermined analysis function identified by the inventors has at least one non-zero value A0, referred to as discontinuity, at a given time referred to as discontinuity time td0, with a return to substantially zero values around said discontinuity. The return is preferably rapid. The analysis function is digitized at sample points (see FIG. 9), and a rapid return to essentially zero values is defined as a decrease that takes place over a small number of sample points. The maximum number of points over which to return to zero depends on Fe, the distance between objects, the amplitude of the echoes . . . . In short, separation performance is improved when the decrease takes place over a small number of sampling points, but there is always a gain, however small, when the analysis function has one or more slopes greater than that (those) of the impulse response.

What's important is that this decrease acts as a discontinuity (break in slope) with respect to the slow variation in hr(t). Typically, the descent is made over a few to about ten sampling points at most.

Finally, in step C, a distance di to element Ei (obstacle i) is determined from the processed signal sₚ^{e}(t)). This determination is carried out by processing 70, which consists of locating the local maximum(s) of sₚ^{e}(t)), and the time(s) tmi corresponding to this local maximum(s). This temporal location of the local maximum tmi corresponds to the delay or time of flight Ri for the associated obstacle Ei, tmi=Ri, and the obstacle's distance di is deduced from this instant tmi, using formula (1).

Local maximums are searched for in a time range of interest, depending on the application and/or what is being searched for. We are particularly interested in the obstacle closest to the object on which the lidar is mounted and its distance from the lidar. The distance of interest at which the scene is probed in front of the lidar depends on the application.

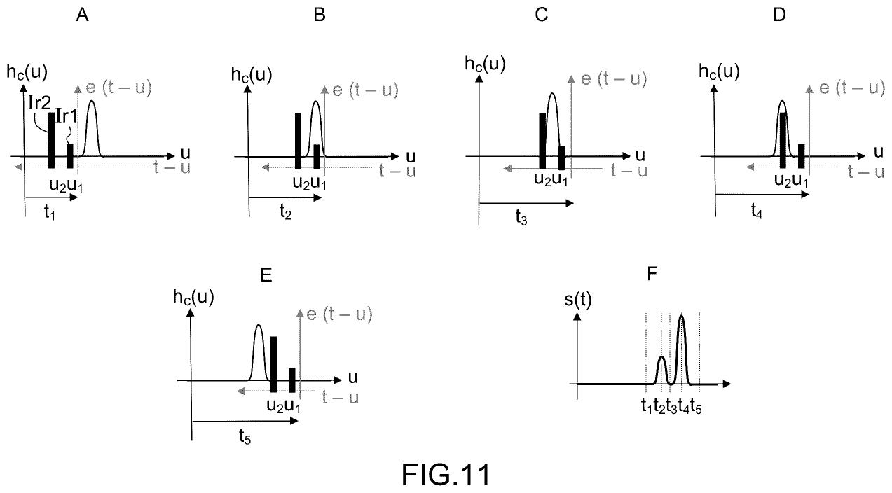

By way of illustration, FIG. 11 shows the effect of a Gaussian analysis function hc(u) with a single discontinuity (by discontinuity we mean a maximum with a return to values close to zero) on a signal Ir comprising two pulses Ir1 and Ir2. Curves A to D illustrate different convolution times.
t=t₁: None of the pulses interact with the corrected impulse response hc.
t=t₂: The pulse lr1 interacts with the corrected impulse response h_{c} but not the pulse lr2
t=t₃: The pulse lr1 no longer interacts with h_{c}, resulting in a net decrease in common areas and therefore in the output signal
t=t₅: In turn, the pulse lr2 no longer interacts with h_{c}, causing a further net decrease in the output signal

Curve F shows the result of convolution processing hc*Ir:

$$hc * Ir = Ir * hc = Ir * hr * C = {s}_{0} * C = {s}_{p}$$

The introduction of at least one discontinuity allows the interaction of the two pulses with the impulse response to be dissociated at some point, and enables the arrival times of the echoes to be clearly discerned.

In this way, the lidar according to the invention can detect a small obstacle in front of a larger one, such as a smooth wall at an angle.

The lidar according to the invention offers advantages not available to ultrasonic sensors, and can therefore replace them in robotic collision avoidance. It offers enhanced features in terms of:
sensitivity to weather conditions: insensitive to rain or high humidity,
detection field: width of the order of 5° or 10° or 20° or 30°,
detectivity: detection of thin or poorly reflective objects,
obstacle separation: discernment of closely spaced obstacles, detection of a thin object in front of a wide one, detection of multiple echoes in close proximity, despite the low bandwidth of the amplification circuit,
acquisition: flash lidar, “single-shot” system possible (one laser shot=1 result)
refresh rate: high, over 10 kHz

Designed for portable, on-board applications, it also offers interesting integration features:
low power consumption (single-shot): can be powered by batteries
small dimensions: a few cm³ are possible
reduced mass: a few grams are possible,
low cost.

It is adaptable: Adding optics increases its range, while retaining echo discernment capabilities.

These characteristics mean that lidar can be used in the fields of robotics, drones, autonomous movement, anti-collision, etc

Detection of multiple nearby echoes makes it possible, among other things, to:
provide a better understanding of the surrounding terrain and enable better trajectory anticipation,
detect and take into account weak echoes due to small obstacles placed closer than large ones,
improve drone or robot movement in dense environments, such as urban areas or forests.

The signal processing according to the invention, enabling discernment of multiple echoes with little computing power, may be of interest for other equipment measuring time of flight, in the fields of reflectometry, sonar, etc. and for monitoring premises.

The single-axis design also makes the lidar more discreet.

A sampling frequency Fₑ corresponds to a sampling period Tₑ, the amount of time after which the digital system recalculates its information. The sampling period corresponds to the temporal resolution of the measurement, i.e. the spatial discernment resolution in the case of lidar.

The current time resolution Tₑ corresponds to a spatial resolution of Tₑ/6.67 ns. In concrete terms, the sampling frequency is set by the reference of the analog-to-digital converter (ADC) used, and determines the spatial discernment resolution between obstacles. For example:

75 cm@Fₑ=200 MHz

37.5 cm@Fₑ=400 MHz

5.5 cm@Fₑ=3000 MHz

By generating one or more discontinuities in the impulse response of the processing chain, the discernment power is no longer linked to the receiver's bandwidth but to the sampling frequency of the digital system: The signal processing according to the invention makes it possible to use a low-bandwidth receiver for its sensitivity and S/N (signal-to-noise) ratio qualities, while still benefiting from a high discernment capacity.

For improved sensitivity, the at least one discontinuity time td0 is preferably chosen in the vicinity of the instant of maximum impulse response hᵣ(t), referred to as tm-imp. The vicinity of tₘ₋ᵢₘₚ is taken to mean an instant located in a time interval around tₘ₋ᵢₘₚ such that the amplitude of the impulse response hr associated with this instant is greater than or equal to a non-zero fraction of the maximum amplitude of hr, preferably greater than or equal to the maximum amplitude divided by 4. Preferably, the at least one discontinuity time td0 coincides with tₘ₋ᵢₘₚ.

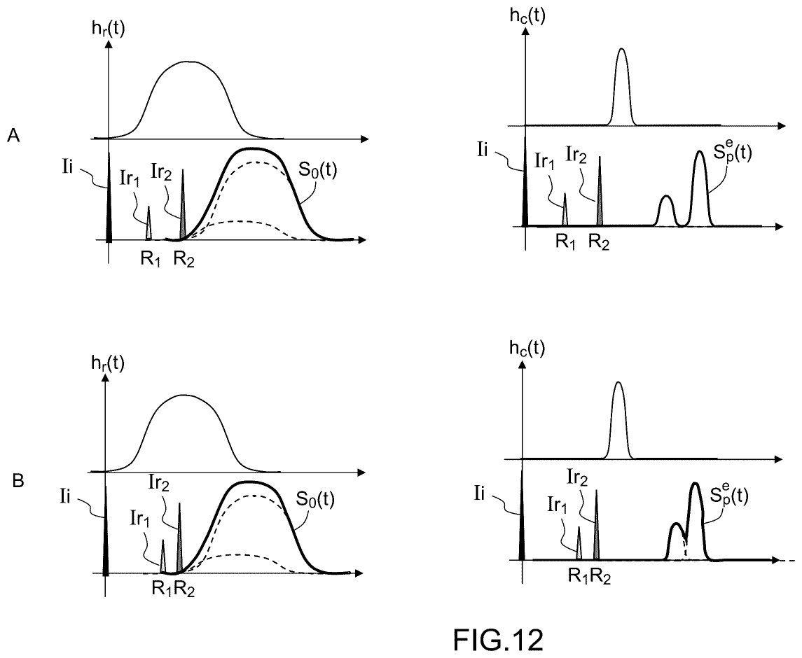

FIG. 12 shows a limitation of using an analysis function with only one discontinuity of a given width. The curves on the left are equivalent to the noise-free curve in FIG. 5, and illustrate the result of convolution with the unprocessed impulse response hr. The curves on the right illustrate convolution with the Gaussian analysis function. Curves A and B correspond respectively to two pulses Ir1 and Ir2 separated by two different times, and more precisely to obstacles that are further apart for A and closer for B. When the echo pulses are sufficiently far apart (with respect to the width of the Gaussian), good separation is obtained (case A). For case B, the separation is of average quality. An analysis function of a certain width (Gaussian in the example) may be sufficient to achieve obstacle separation, but its non-zero width makes it less efficient than a Dirac function (infinitely narrow discontinuity).

The inventors have identified three types of analysis functions that are particularly relevant when used in combination.

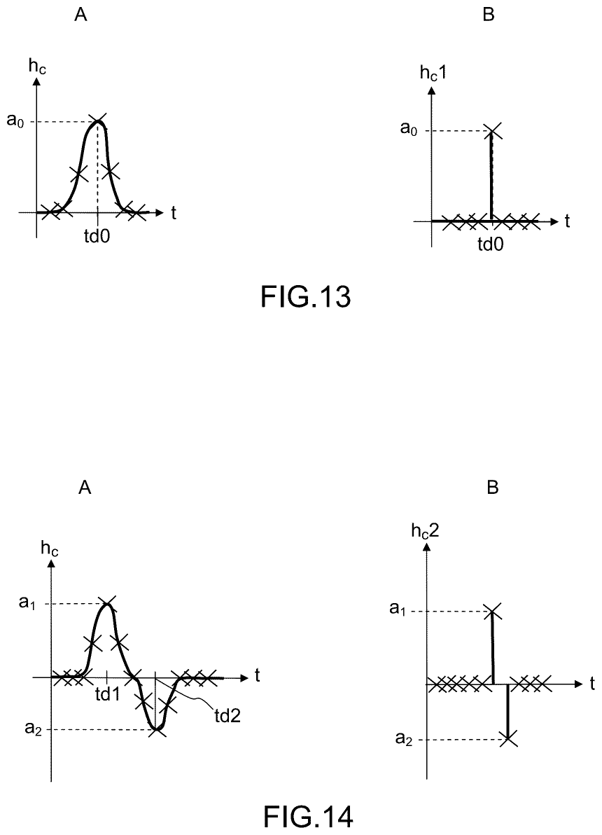

The first type, shown in FIG. 13 and already commented on, is an analysis function with a single discontinuity (A0, td0). The function A on the left corresponds to a non-zero value A0 and a return to zero values at a sampling point (cross) on each side.

The best results were obtained with a function as shown in B on the right, which has zero values outside the A0 discontinuity, also known as simple Dirac. The discontinuity is then as steep as possible. Preferably td0=tₘ₋ᵢₘₚ.

The second type, shown in FIG. 14, is an analysis function with two discontinuities, a first discontinuity A1 at a first discontinuity time td1 and a second discontinuity A2 at a discontinuity time td2, td1 and td2 being close in time, that is separated by a few sampling points, as the aim here is to separate close echo pulses.

Function A on the left corresponds to non-zero values A1 and A2, with a return to zero values at one sampling point on each side, for both discontinuities (as an example). Again by way of example, there are three sampling points between times td1 and td2. Preferably, for a better efficiency of the function, two discontinuities of different signs are chosen, one discontinuity of positive value and one discontinuity of negative value. In the example A1>0 and A2<0. For example, we place td1 at tₘ₋ᵢₘₚ, but it could be td2, or tₘ₋ᵢₘₚ is located between td1 and td2. The important thing is that td1 and td2 are located in the vicinity of tₘ₋ᵢₘₚ.

The best results were obtained with a function as shown in B on the right, which has zero values outside the A1 and A2 discontinuities, separated from the minimum possible, i.e. no sampling points, also known as dual-Dirac. Here, the return to zero is achieved in less than one sampling point, and the slope between the two discontinuities is as steep as possible. For example, we place td1 at tₘ₋ᵢₘₚ, but it could be td2.

The third type is an analysis function with three discontinuities close together in time.

In one embodiment, the inventors have shown that these types of function provide improved treatment when combined. This is made possible by the simplicity of the calculation process. Thus, according to this variant, a plurality of correcting filters Cj(t) (j filter index) are applied, precalculated from a plurality of predefined analysis functions hcj(t), so as to generate a plurality of associated complementary processed signals sfj(t).

The distance of the scene elements Ei is determined from the plurality of processed signals, by detecting local maximums and comparing their respective positions in the different processed signals.

One example is the detection of the obstacle closest to the lidar. In one embodiment, the first type of analysis function is used to identify the time range of interest wherein the nearest obstacle is detected. Then the application of correcting filters determined from the second type of analysis function, with different values for A1 and/or A2, enables the final locating of this closest obstacle in the time range of interest, allowing the presence of echoes, for example of very low amplitudes and masked by others of greater magnitude, to be scrutinized locally. In fact, the inventors have shown that a single discontinuity analysis function allows a complete scan of the space of interest (but may lack precision), whereas a two-discontinuity analysis function performs a “magnifying glass” function close to the nearest obstacle (see example below).

For example, when A2=−A1, the analysis function presented is equivalent to a derivative, commonly used for local studies of functions or signals. As a result, said analysis function will provide the derivative of the sum of the echoes, providing additional information on their location.

According to another example, the function with three discontinuities, for example equal to +1, −2, and +1 respectively, is equivalent to a second derivative.

Of course, the three types of mono, bi and tri Dirac functions described below are only examples of possible analysis functions. Other analysis functions, specific to the pulses emitted, can also be envisaged to refine echo detection.

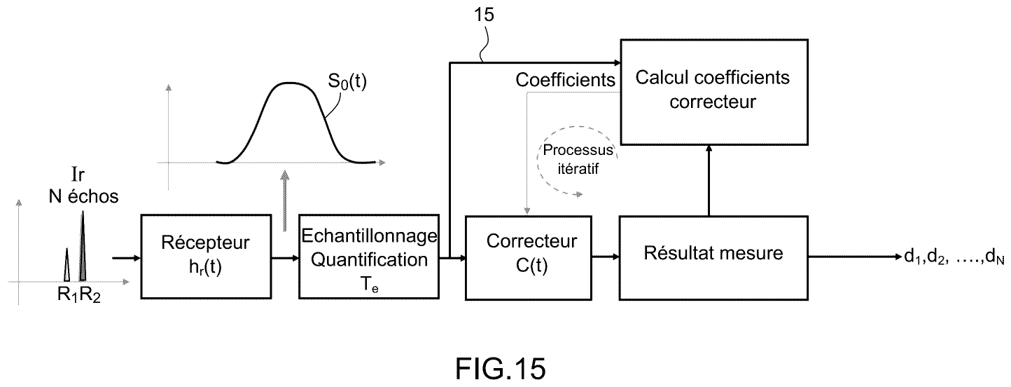

In one variant, the plurality of correcting filters is applied via an iterative process, as shown in FIG. 15, until a final processed signal allows for a distance to be determined corresponding to the desired obstacle, typically the nearest obstacle. In this case, the filters are determined progressively in the loop, by recalculating coefficients c0, and/or c1/c2, and/or c1,c2 and c3, according to the result obtained, that is the processed signal spj(t), and more particularly the position of the local maximum(s). The iterative process consists in modifying discontinuities, that is non-zero values of said analysis functions. An optional branch 15 measures the impulse response of the receiving device. In one embodiment, this measurement is carried out regularly during the implementation of the method according to the invention.

The iteration loop stops when the temporal location of the maximum of the obstacle of interest, in this case the closest one, no longer varies, meaning that this obstacle has been separated from the others.

According to one embodiment of the iterative process, a correcting filter corresponding to an analysis function with a single discontinuity A0 is first applied, followed by analysis functions with a first and a second discontinuity (A1, A2) at two discontinuity times (td1, td2) that are temporally close together, and/or analysis functions with three discontinuities at three discontinuity times that are temporally close together, the discontinuities being iteratively modified.

Simulations have been carried out on a lidar according to the invention. Experimental measurements have also been carried out, with experimental results close to those of the simulations, demonstrating the validity of the calculation. Here we are looking for the distance to the nearest obstacle in a situation with three obstacles in a first configuration.
Obstacle 1: d=0.7 m−amplitude: 1
Obstacle 2: d=1.7 m−amplitude: 1
Obstacle 3: d=6 m−amplitude: 5

The simulation parameters are as follows:
Sampling frequency Fe=400 MHz (one point every 2.5 ns), 10-bit sampling
Amplifier circuit: R=300 k□ Bandwidth: 2.7 MHz

The temporal extension of hr(t) is 200 ns, i.e. 80 sampling points.

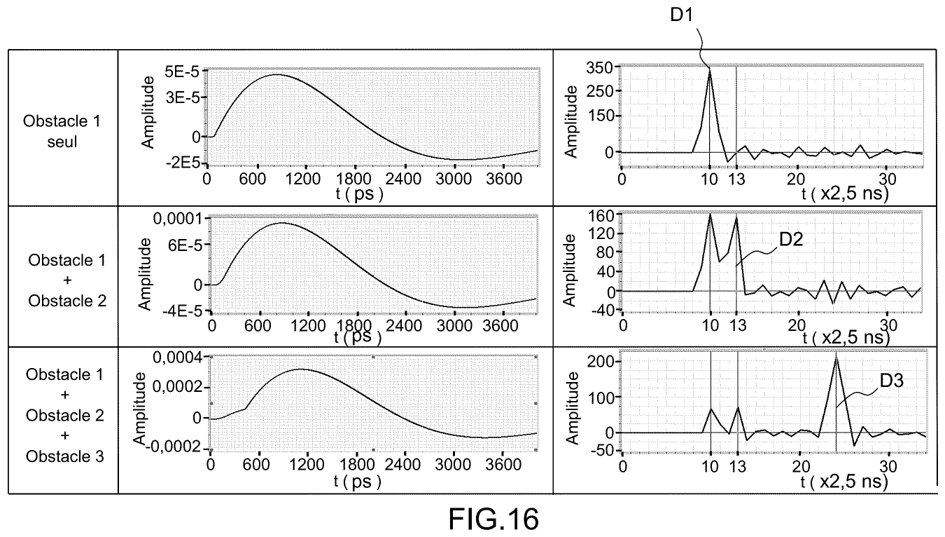

FIG. 16 shows the raw and processed lidar signals for three situations:

(1): Obstacle 1 only, (2): Obstacles 1 and 2, (3): Obstacles 1, 2 and 3 in the scene.

The straight lines D1, D2 and D3 represent the exact position of the three lagging obstacles.

The curves on the left illustrate the raw signal s₀(t) at the receiver output, as shown in FIG. 5. The curves on the right illustrate the processed signal sₚ^{e}(t), with the X-axis corresponding to the quantum of time (sampling points) i.e. 2.5 ns (to which corresponds a quantum of distance 2.5/6.67=37.5 cm).

The position of the first obstacle is at X-axis 10, i.e. a delay of 25 ns. This does not correspond directly to the position of the first obstacle, as there is a time offset, perfectly understood, which depends directly on the Dirac position of the analysis function.

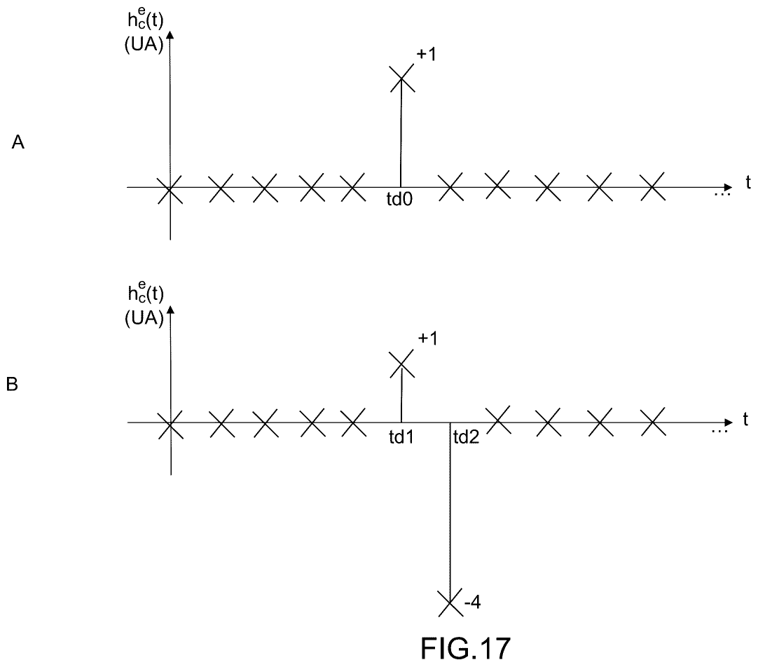

The simulation is carried out with an analysis function he of the first simple Dirac type, as shown in FIG. 17-A: a single discontinuity, of amplitude A0=1 for a sampling point at time td0=20 ns, and zero values for the other times.

Note that in this configuration of obstacles, the first type of analysis function identifies the three obstacles and separates them.

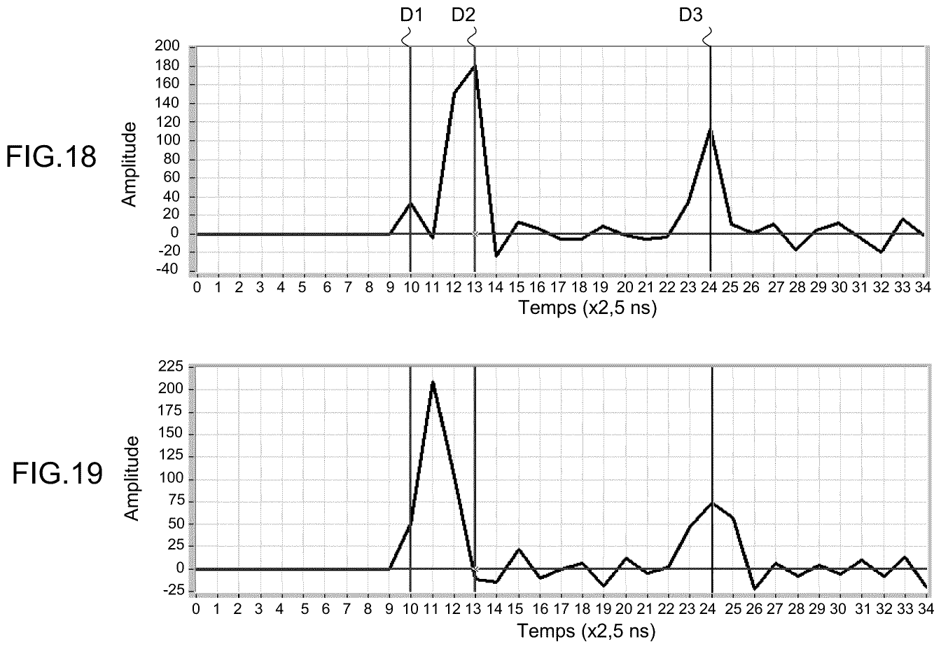

FIG. 18 shows the signal processed with the same analysis function as before for the following second obstacle configuration:
Obstacle 1: d=0.7 m−amplitude: 1
Obstacle 2: d=1.7 m−amplitude: 10
Obstacle 3: d=6 m−amplitude: 5

The echo of obstacle 2 is much greater here. Note on the curve that the peak associated with the first obstacle is still visible, but weaker. For obstacles that are too close and/or with a strong second obstacle, the limitation of the simple Dirac function becomes apparent.

FIG. 19 shows the signal processed with the same analysis function as before for the following third obstacle configuration:
Obstacle 1: d=0.7 m−amplitude: 1
Obstacle 2: d=1.2 m−amplitude: 10
Obstacle 3: d=6 m−amplitude: 5

Obstacle 2 has been moved closer to obstacle 1. Note that the first two obstacles are no longer discerned by the simple Dirac analysis function, and that the processed signal corresponds to a fictitious obstacle located between the two real obstacles.

To solve this problem and accurately identify the position of the nearest obstacle, a dual-Dirac analysis function is applied, preferably in an iterative process.

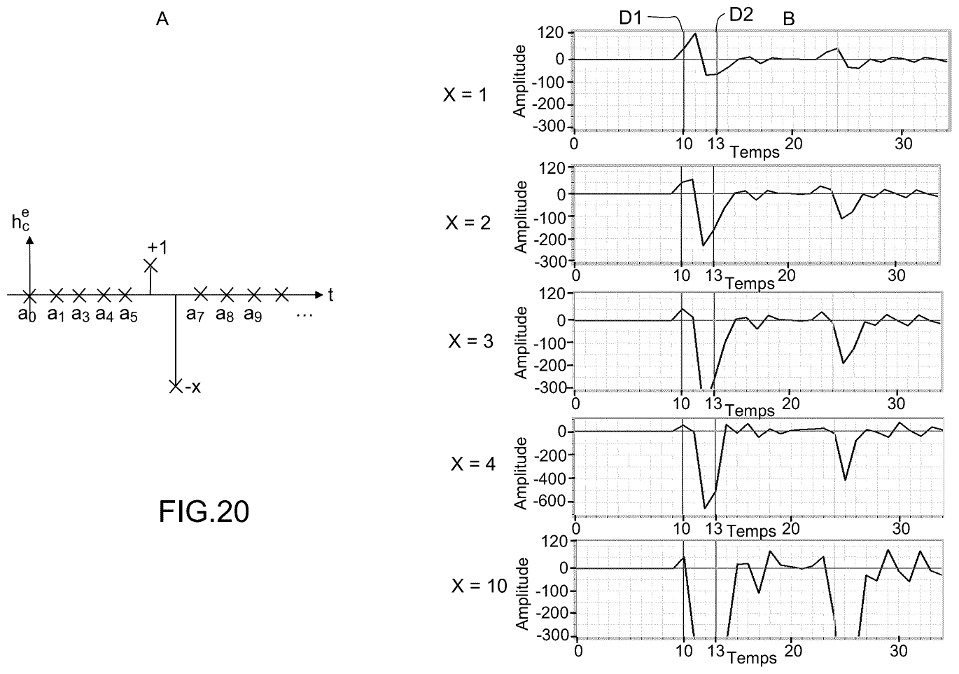

FIG. 20 shows the signals processed with the dual-Dirac analysis function, illustrated in A, for the third obstacle configuration. B shows the different processed signals obtained for different values of a6, which is increased by 1 at each iteration. It can be seen that between the first two iterations X=1 and X=2 and the third iteration X=3, the position of the first obstacle is not stabilized, and varies. It's time to continue the iteration.

For subsequent iterations, this position becomes stable; once the position of the first obstacle has stabilized, the process can be stopped.

Note that when applying the dual-Dirac, only the position of the first obstacle needs to be taken into account. What happens afterwards (temporally) is not to be considered.

In one variant, the amplifier circuit CA of the lidar 10 according to the invention features an additional component.

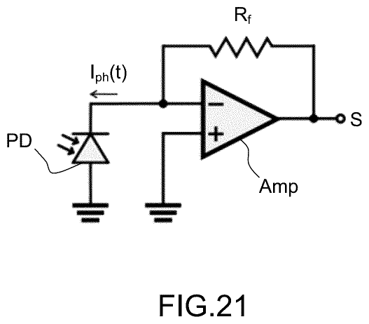

Classically, the most suitable and widely-used receiver circuit associated with a photodiode PD is called a Trans Impedance Amplifier (TIA). Its elements are well known to professionals. In its most basic form, it consists of a resistor R_{f} and an operational amplifier Amp, as shown in FIG. 21.

Considering the ideal components:
The PD photodiode transforms the luminous flux into the photogeneration current Iₚₕ.
The TIA transforms the current Iₚₕ into voltage according to the relationship S=−R_{f}Iₚₕ.
The value of the resistor R_{f} determines the amplifier gain. TIA sensitivity is linked to this value.

A PIN-type photodiode is preferred, as it is more reliable and simpler to operate than an avalanche photodiode (APD).

The current from the photodiode can be described by the relationship:

$${i}_{p h} ( t ) = S \cdot {∅}_{e} ( t ) + {I}_{0} + {i}_{{n}_{p h}} ( t ) \qquad ( 9 )$$

Wherein:
S is the sensitivity of the photodiode, on the order of 0.6 A/W,
Øₑ(t) is the received light power,
I₀ is the sum of the photodiode's reverse static currents (saturation current, black current),
iₙ_{ₚₕ}(t) represents the sum of the photodiode's intrinsic noise (mainly shot noise).

The captured light power Øₑ(t) is made up of a dynamic part φₑ(t) such as the reflected pulse, and a static part caused by an illuminated background Øₑ₀, caused by the sun for example (see also formula (3) and A0). The relationship is then written:

$${i}_{p h} ( t ) = S \cdot ( {φ}_{e} ( t ) + {∅}_{e 0} ) + {I}_{0} + {i}_{{n}_{p h}} ( t ) \qquad ( 10 )$$

A PIN photodiode generates around 600 mA/W. The transimpedance amplifier's gain is generally a compromise between the desired bandwidth and the sensor's sensitivity (detection capability). It can also be limited by the strength of the photodiode's reverse static currents.

In terms of sensor sensitivity and measurement signal-to-noise ratio S/N, it's best to use a highresistance R_{f} leading to high gain (and therefore low bandwidth).

Ambient brightness is amplified in the same way as optical echo signals. The orders of magnitude are very different between the currents generated by echo pulses (typically a few μA for an echo of a few μW) and that induced by ambient brightness (typically a few tens of mA for a 5×5 mm² silicon photodiode).

To limit the photogeneration current induced by the sun, which can lead to TIA saturation, an optical filter is conventionally placed just above the photodiode surface. It can be the colored filter integrated into the photodiode proposed by manufacturers (broad spectrum on the order of 300 nm), or an interference filter (narrow spectrum on the order of 10 nm—entails a major directivity drawback).

However, despite the presence of a filter, an output voltage S higher than the TIA supply voltage (typically 5V) is quickly reached with a high resistance Rf and average ambient illumination (sun), leading to sensor saturation.

As a result, the sensor's performance in full sunlight is counterproductive to the use of a high-sensitivity TIA. A compromise on the gain is necessary:
The importance of high gain (high TIA resistance R_{f}) in obtaining the high S/N needed to detect obstacles with low echo reflection
Preference for low gain (low-value TIA resistor R_{f}), so as to favor high bandwidth for obstacle discernment
Preference for low gain (low value TIA resistor R_{f}) to keep the sensor in full sunlight

These conflicting points illustrate the difficulty of creating a wide-field proximity lidar capable of discriminating between different obstacles included in the detection field and close to it, and characterizing their distances, while maximizing the chances of detecting the closest obstacle.

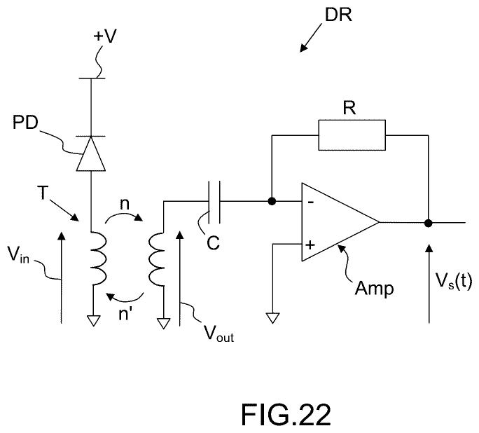

In order to solve the problem of holding the sensor in direct sunlight, the receiving device DR of the lidar 10 according to the invention includes a transformer T and a capacitor C between the photodetector PD and the amplifier TIA, as shown in FIG. 22. The primary coil of the transformer is connected to the anode of the photodetector, while the secondary is connected to capacitor C, which is connected to an input of the transimpedance amplifier.

The transformer can be either step-down (Vout<Vin, Iout>Iin) or step-up (Vout>Vin, Iout<Iin). Preferably, the transformer is a step-down transformer, enabling the photodiode current of the transformation ratio to be amplified without adding additional noise.

The transformer's operating principle lies in the conversion of a current at its primary (here the photodiode current iₚₕ(t)=S. (φₑ(t)+Øₑ₀)+I₀) into a magnetic field B(t), itself reconverted into an electric field E(t), hence into a voltage sₜ(t) (Vout) at the transformer's secondary.

It is known that the electric field is a function of the derivative of the magnetic field induced by iₚₕ(t). Consequently, the voltage and current of the transformer depend only on variations in iₚₕ (t)). The voltage from the TIA will be of the form:

$${V}_{s} ( t ) = k \cdot \frac{d}{d t} {φ}_{e} ( t ) \qquad ( 11 )$$

Without characterizing the coefficient k, it is established here that all static components of the photodiode current iₚₕ (t)) are eliminated at the transformer secondary:
Parasitic intrinsic reverse photodiode currents (saturation current, black current)
Photo-generated currents due to any light source, weak or intense (sun).

The role of the capacitor C placed between the TIA and the transformer is to minimize the gain that the system would have without this capacitor. In fact, this assembly would behave like a non-inverting amplifier with infinite gain with respect to the offset voltage of the AOP, resulting in saturation.

The structure of the receiving device DR according to the invention therefore solves two problems:
The gain resistance limit is lifted, as the various parasitic DC currents are filtered out. A very high-gain sensor is created and the detection capacity is improved.
The sensor virtually ignores ambient lighting. It is then possible to detect obstacles when facing the sun.

This structure is perfectly suited to the use of a wide-F.O.V. lidar outdoors.

1-12. (canceled)

13. A method for processing a signal from a lidar, said lidar performing a time-of-flight measurement and comprising an emitting device configured to emit light pulses in the direction of a scene at an angle greater than or equal to 5° and a receiving device, said receiving device exhibiting an impulse response (hr(t)) and comprising a photodetector configured to receive pulses reflected or backscattered by at least one element (Ei) of the scene and to convert said pulses into an electrical signal, and an amplification circuit (CA) configured to generate an amplified electrical signal (s₀(t)),
the method comprising the steps of:
A: digitizing the amplified electrical signal (s₀^{e}(t))
B: applying at least one time correction function, referred to as the correcting filter (C^{e}(t)), to the digitizing amplified electrical signal in order to generate a processed signal (sf(t)),
the correcting filter (C^{e}(t)) being determined based on the impulse response and a predetermined time analysis function, the analysis function having at least one non-zero value (a0, a1, a2), referred to as the discontinuity, at a given time referred to as the discontinuity time (td0, td1, td2), with a return to substantially zero values around the discontinuity,
C: determining a distance (di) of said at least one element (Ei) based on the processed signal.

14. The processing method according to claim 13, wherein applying the correcting filter consists in convolving the digitized amplified electrical signal with said correction time function, and wherein said correcting filter is determined by deconvolution of said impulse response by said predetermined analysis function.

15. The processing method according to claim 13, wherein a presence of said at least one element in said scene corresponds to a local maximum of said processed signal, and said associated distance is determined from a temporal location of said local maximum.

16. The processing method according to claim 13, wherein said impulse response has a maximum at a time tₘ₋ᵢₘₚ, and wherein said at least one discontinuity time of the analysis function is located temporally in the vicinity of said time tₘ₋ᵢₘₚ.

17. The method according to claim 13, wherein the analysis function has zero values outside said at least one discontinuity.

18. The method according to claim 13 wherein the analysis function has either a single discontinuity (A0), or two discontinuities, or three discontinuities, located respectively at discontinuity times close together in time.

19. The processing method according to claim 13, wherein a plurality of correcting filters (Cj(t)) determined from a plurality of analysis functions (hcj(t)) are applied, so as to generate a plurality of associated processed signals (sfj(t)), said distance of said at least one element in the scene being determined from said plurality of processed signals.

20. The processing method according to claim 19, wherein said plurality of correcting filters is applied via an iterative process, until a final processed signal allows the determination of a distance corresponding to the nearest obstacle.

21. The processing method according to claim 20, wherein the iterative process consists in modifying discontinuities, that is non-zero values of said analysis functions.

22. The processing method according to claim 21, wherein a correcting filter corresponding to an analysis function with a single discontinuity (A0) is first applied, followed by analysis functions with two discontinuities or three discontinuities, said discontinuities being iteratively modified.

23. A time-of-flight lidar system comprising:
an emitting device (DE) configured to emit light pulses towards a scene at an angle greater than or equal to 5°
a receiving device (DR) having an impulse response (hr(t)) and comprising:
a photodetector (PD) configured to receive pulses (Ir) reflected or backscattered by at least one element (Ei) in the scene, and to convert said pulses into an electrical signal,
an amplification circuit (CA) configured to amplify said electrical signal,
a processing unit (UT) of said amplified electrical signal configured to:
digitize the amplified electrical signal (s₀^{e}(t))
apply at least one time correction function, referred to as the correcting filter (C^{e}(t)), to the digitizing amplified electrical signal in order to generate a processed signal (sf(t)), the correcting filter (C^{e}(t)) being determined based on the impulse response (hr(t)) and a predetermined time analysis function, the analysis function having at least one non-zero value (a0, a1, a2), referred to as the discontinuity, at a given time referred to as the discontinuity time (td0, td1, td2), with a return to substantially zero values around the discontinuity; o determine a distance (di) of the at least one element (Ei) based on the processed signal.

24. The lidar system according to claim 23, wherein the amplification circuit (CA) comprises a transimpedance amplifier (TIA), a transformer comprising a primary and a secondary, and a capacitor (C), the primary of the transformer being connected to an anode of the photodetector, the secondary being connected to a capacitor, said capacitor being connected to an input of said transimpedance amplifier.
